(19) United States
(12) Patent Application Publication
(10) Pub. No.: US 2019/0054824 A1
(43) Pub. Date: Feb. 21, 2019

(54) APPARATUS AND METHOD FOR VEHICLE INFORMATION DISPLAY

(71) Applicant: Jaguar Land Rover Limited, Whitley, Coventry, Warwickshire (GB)

(72) Inventors: Paul YOUDAN, Whitley, Coventry (GB); Ashutosh TOMAR, Whitley, Coventry (GB)

(21) Appl. No.: 16/078,906

(22) PCT Filed: Mar. 22, 2017
(86) PCT No.: PCT/EP2017/056876

§ 371 Date: Aug. 22, 2018

(30) Foreign Application Priority Data
Mar. 22, 2016 (GB) 1604775.5

(51) Int. Cl. B60K 35/00; B60K 37/06

(52) U.S. Cl. CPC B60K 35/00; B60K 37/06; B60K 2350/108; B60K 2350/357; B60K 2350/352

(57) ABSTRACT

Embodiments of the present invention provide a vehicle comprising a moveable cover and a self-contained display means arranged in relation to the cover such that said display means is arranged generally behind the cover when in a closed position, the display means comprising energy harvesting means for harvesting energy for powering for the self-contained display means, communication means for wirelessly communicating with vehicle communication means to obtain vehicle information, and visual display means for visually outputting an indication of the vehicle information.

### TECHNICAL FIELD

The present disclosure relates to a self-contained display for a vehicle and, in particular although not exclusively, to a self-contained display for displaying vehicle information. Aspects of the invention relate to vehicle comprising a self-contained display means, to a self-contained display device for a vehicle and to a method of providing vehicle information.

### BACKGROUND

Vehicles often include self-monitoring functionality to, for example, monitor consumption of consumables such as some of, but not limited to, fuel, oil, screen-wash, brake pads etc. The self-monitoring functionality can provide information to an occupant of the vehicle, particularly the driver, via a graphical user interface (GUI) of the vehicle, which may be incorporated into a dashboard of the vehicle. However, often, vehicle occupants do not regularly access a self-monitoring menu of the GUI and so are unaware of a state of the vehicle, such as when the consumables need to be replaced.

It is an object of embodiments of the invention to at least mitigate one or more of the problems of the prior art.

### SUMMARY OF THE INVENTION

Aspects and embodiments of the invention provide a vehicle, a self-contained display device for a vehicle, a method of providing vehicle information, and computer software as claimed in the appended claims.

According to an aspect of the invention, there is provided a vehicle, comprising a moveable cover and a display means arranged in relation to the cover such that said display means is arranged generally behind the cover when in a closed position, the display means being arranged to visually output an indication of vehicle information when said cover is in an open position. The cover may be an external cover of the vehicle. The cover may form part of an external surface of the vehicle. The cover may be a cover of a fuel connection to the vehicle. Advantageously, the vehicle information is provided when a user of the vehicle has a low cognitive load and is able to appreciate the information.

According to an aspect of the invention, there is provided a vehicle, comprising a moveable cover and a self-contained display means arranged in relation to the cover such that said display means is arranged generally behind the cover when in a closed position, the display means comprising energy harvesting means for harvesting energy for powering for the self-contained display means, communication means for wirelessly communicating with vehicle communication means to obtain vehicle information, and visual display means for visually outputting an indication of the vehicle information. Advantageously, the vehicle information is provided when a user of the vehicle has a low cognitive load and is able to appreciate the information. Furthermore, the self-contained nature of the device provides a device, which does not require a wired connection to the vehicle, for example for power-supply or data.

The vehicle described above, wherein:
the energy harvesting means for harvesting energy for powering for the self-contained display means comprises an energy harvesting unit,
the communication means for wirelessly communicating with vehicle communication means to obtain vehicle information comprises a communication unit arranged to wirelessly communicate with a corresponding communication unit of the vehicle, and
visual display means for visually outputting an indication of the vehicle information comprises a display device arranged to display information thereon in use.

The display means may be proximal to a fuel connection of the vehicle. The user is likely to have time to appreciate the displayed vehicle information whilst fuelling the vehicle.

The energy harvesting means may comprise solar means for converting incident solar energy into electrical energy. The solar means may be a solar panel. The device may be powered whilst the cover is in the closed position, if said solar panel forms part of a surface of the vehicle, or may be powered when the cover is moved to the open position.

The energy harvesting means may comprise kinetic means for converting kinetic energy into electrical energy. The kinetic means may be a device arranged to convert kinetic energy into electrical energy. The kinetic energy may be provided by movement of the cover between the closed position and an open position. Advantageously movement of the cover provides power for the device to operate at a time when the device is required to be operational, thus an energy storage requirement for the device is reduced.

The energy harvesting means may comprise energy storage means for storing energy to power the self-contained display means. The energy storage means may be an energy storage device. Advantageously the energy storage means allows energy provided over a longer duration than an operating duration of the device to be used.

Optionally the communication means is arranged to communicate with a vehicle communication means to receive the vehicle information there-from. Wireless communication is advantageously convenient for the device to reduce a requirement for wired data communication to the device.

The vehicle information may comprise information indicative of a state of one or more consumables of the vehicle. Advantageously the user is provided information about the state of the consumables at a convenient time.

Optionally the state of the one or more consumables of the vehicle comprise one or more of an oil level of an engine of the vehicle, a coolant level of the vehicle, a screen wash level of the vehicle, a brake wear level, a filter of the vehicle, a fluid level of the vehicle.

In some embodiments, the vehicle information comprises information indicative of a state of one or more vehicle systems. Advantageously the user is provided information about the state of the one or more vehicle systems at a convenient time.

Optionally the information indicative of the state of one or more vehicle systems comprises information indicative of one or more of a braking system, a cooling system, a fuel system, one or more wheels, one or more tyres, a lighting system and a towing system of the vehicle.

The visual display means may be arranged to be visible when the cover is in an open position. The cover may form a surface of the vehicle when closed. Advantageously the device is protected when the cover is closed.

Optionally the display means is substantially sealed. The sealing may be sufficient to be impermeable to liquid, such as liquid fuel, and may be impermeable to gasses. Advantageously the sealing assists in utilisation of the device in a region proximal to a fuel connection of the vehicle, particularly where the vehicle uses liquid or gaseous fuels.

The fuel connection may be one of a liquid, gas or an electrical connection to the vehicle.

Optionally the vehicle information comprises priority information indicative of an importance of the vehicle information. The indication of the vehicle information may be displayed on the visual display means in an order based on the priority information. Advantageously most important information is provided to the user first.

According to a further aspect of the invention, there is provided a self-contained display device for a vehicle, comprising energy harvesting means for harvesting energy for powering the self-contained display device, communication means for wirelessly communicating with a vehicle communication means to obtain vehicle information, and visual display means for visually outputting an indication of the vehicle information.

The display device described above, wherein:
the energy harvesting means for harvesting energy for powering for the self-contained display means comprises an energy harvesting unit,
the communication means for wirelessly communicating with vehicle communication means to obtain vehicle information comprises a communication unit arranged to wirelessly communicate with a corresponding communication unit of the vehicle, and
visual display means for visually outputting an indication of the vehicle information comprises a display device arranged to display information thereon in use.

Optionally the display device is formed in a substantially sealed casing. The substantially sealed casing may be liquid-proof; optionally the casing is substantially impermeable to gasses.

The energy harvesting means may comprise one or more of solar means for converting incident solar energy into electrical energy, kinetic means for converting kinetic energy into electrical energy and wireless means for converting magnetic or RF energy into electrical energy.

Optionally the solar means comprises one or more solar panels arranged on a surface of the device. The surface may be a rear of the device. The surface may, in use, form a portion of an external surface of the vehicle. In some embodiments the surface is a portion of the visual display means.

The communication means may be operative according to a short-range communication protocol to communicate with the vehicle communication means.

Optionally the display means is one of an electrophoretic display device or a bi-stable display device. Advantageously energy is only used to update the display device.

The electrophoretic display device is updated to display the indication of the vehicle information within a predetermined period of time of the energy harvesting means harvesting energy

The communication means may be arranged to communicate with the vehicle communication means immediately following the energy harvesting means harvesting energy. The display device may be updated following receipt of the vehicle information. The display device may be updated immediately following receipt of the vehicle information.

According to a still further aspect of the invention, there is provided a method of providing vehicle information, comprising harvesting energy by a self-contained display device, wherein the display device is arranged proximal to a moveable cover of a vehicle such that the display device is behind the cover in a closed position, wirelessly receiving, at the display device, vehicle information from the vehicle, and visually outputting an indication of the vehicle information from the display device.

The harvesting may be performed responsive to the cover moving from the closed position to an open position. Optionally the harvesting is harvesting of kinetic energy of the cover opening.

The wirelessly receiving may be performed dependent on the harvesting of the energy.

The visually outputting may comprise updating a display device to display the vehicle information. The display device may not substantially consume energy following the updating i.e. the output of the display device may be stable following the updating.

According to an aspect of the invention, there is provided computer software which, when executed by a computer, is arranged to perform a method according to aspect of the invention. The software may be stored on a computer-readable medium. The software may be tangibly stored on a computer-readable medium.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1 shows an embodiment of the invention arranged in use;

FIG. 2 schematically illustrates an embodiment of the invention;

FIG. 3 shows a method according to an embodiment of the invention;

FIG. 4 shows a timing diagram illustrating operation of an embodiment of the invention; and

FIG. 5 illustrates a vehicle according to an embodiment of the invention.

### DETAILED DESCRIPTION

Embodiments of the invention provide a self-contained display means for a vehicle. The self-contained display means is arranged to provide, in use, an indication of vehicle information. The self-contained display means may be arranged, in use, behind a moveable cover of a vehicle i.e. in such a position that the self-contained display means is located behind the cover when in a closed position. When the cover is moved to an open position the self-contained display means is visible to a user to provide the indication of vehicle information to the user. The cover is an external cover of the vehicle i.e. one that forms an external surface of the vehicle. In some embodiments the cover is for a fuel connection of the vehicle such as a liquid or gas fuel filler or electric charging port cover. The cover may be a fuel filler or electric charging port flap.

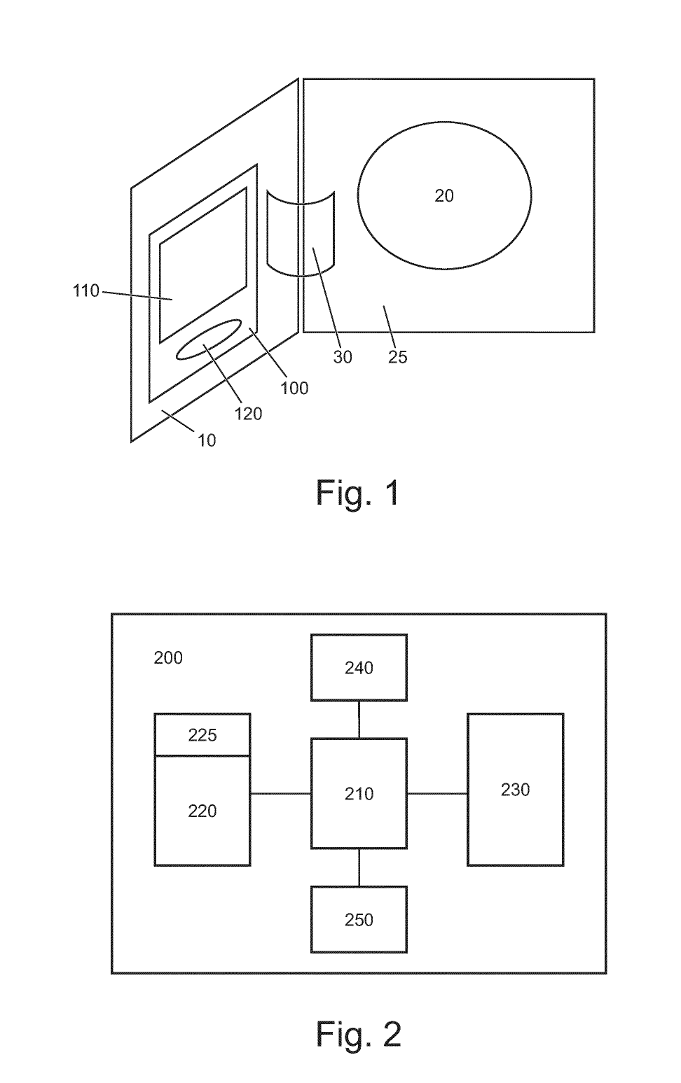

FIG. 1 illustrates a self-contained display means 100 for a vehicle according to an embodiment of the invention arranged in use. The self-contained display means 100 is arranged proximal to a moveable cover 10 of a vehicle. The cover 10, in the embodiment illustrated in FIG. 1, is moveable between an open position and a closed position. The cover 10 may be moved manually i.e. actuated by a user or by actuating means (not illustrated). In the open position as illustrated in FIG. 1 the self-contained display means 100 is visible to the user so that the user may view one or more visual indications provided by the self-contained display means 100. In the closed position the self-contained display means 100 is covered by cover 100 i.e. is not visible from an exterior of the vehicle. The cover 10 may form, in the closed position, a portion of an outer surface of the vehicle. The cover 10 may also cover the fuel connection 20, such as one or both of the liquid or gas fuel filler or electric charging port of the vehicle. In the embodiment illustrated in FIG. 1 the self-contained display means 100 is arranged on an interior surface of the cover 10, although it will be realised that the self-contained display means 100 may be located in other positions whilst still being covered by the cover 10 when closed, such as in a region 25 around the fuel connection 20. The cover 10 is mounted upon a mechanism such as a hinge means 30 for permitting movement of the cover 10 between the open and closed positions.

The self-contained display means 100 comprises a display means 110 for visually displaying information to the user thereon. In some embodiments, the self-contained display means 100 comprises a user input means 120 for changing the information displayed on the display means 110. The user input means 120 is a means for receiving a physical input from the user. It will be realised, however, that the user input means may be otherwise envisaged, such as an audio input means for receiving a voice instruction from the user.

The self-contained display means 100 is, in one embodiment, a unitary display device 100. That is, the display device 100 is formed as a stand-alone device which is self-powered. Furthermore the display device 100 wirelessly communicates with a wireless communication system of the vehicle to receive the vehicle information for display on the display means 110. In some embodiments the display device 100 is formed in a substantially sealed construction. In particular, in some embodiments, the display device 100 is substantially waterproof and may also be substantially gas or vapour proof i.e. substantially impermeable to matter in a gaseous state. Advantageously such construction allows the display device 100 to be located proximal to the fuel connection 20. Particularly where the fuel connection 20 is for gas or liquid fuels, such as petrol, diesel, liquefied petroleum gas (LPG), hydrogen etc., the display device being of substantially sealed construction and stand-alone, i.e. without wired connection to any other systems or devices, increases safety associated with the device 100 in said location. Furthermore as a user of the vehicle is likely to spend a period of time proximal to the fuel connection 20 i.e. whilst at least connecting a fuel supply, such as a liquid, gas or electrical supply to the vehicle, but also in some embodiments whilst the vehicle is receiving fuel, with little cognitive load, the present inventors have realise that this is an opportunity for advantageously providing the user with the vehicle information.

Referring to FIG. 2, a self-contained display means 200 according to an embodiment of the invention comprises processing means 210, energy harvesting means 220 for obtaining power for the self-contained display means 110, communication means 230 for wirelessly communicating with one or more systems of the vehicle to obtain vehicle information, and visual display means 240 for visually outputting an indication of the vehicle information. In some embodiments the self-contained display means 100 comprises user input means 250, as noted above. The energy harvesting means 220 may comprise energy storage means 225 for storing energy for allowing the display means 200 to operate for a period of time to complete its functions, as will be explained.

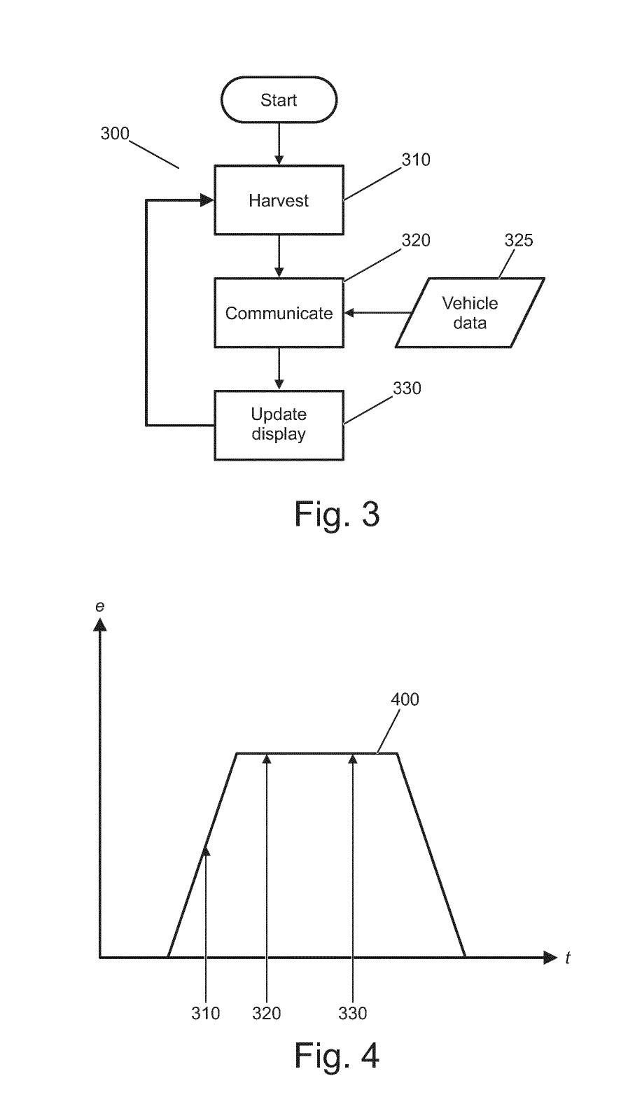

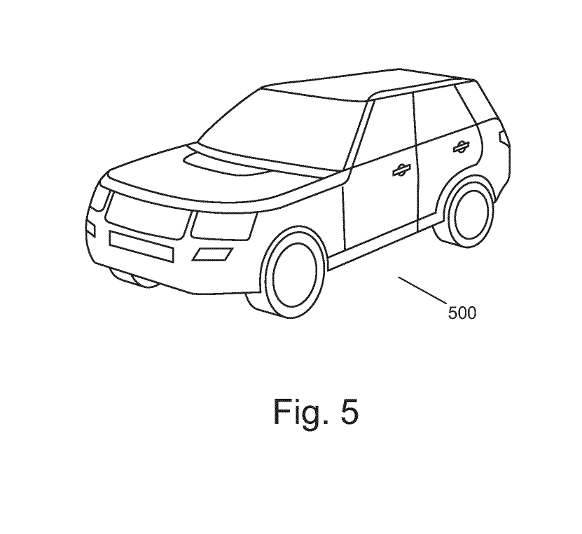

Further description will be provided of the self-contained display means 200 being the self-contained display device 200. The self-contained display device 200 comprises the processing means 210 which may be one or more processing devices i.e. processors which may be associated with a memory means in the form of one or more memory devices (not specifically shown in FIG. 2). The processing means 210 provides a control unit 210 for the self-contained display means 200. The memory means may store computer-executable instructions for implementing a method according to an embodiment of the invention, such as will be described with reference to FIG. 3.

As noted above, the energy harvesting means 220 is provided for obtaining energy for powering the device 100 to operate which may comprise the energy storage means 225 storing energy for a period of time. The period of time may be sufficient for the device 200 to complete a method according to an embodiment of the invention. The energy harvesting means 220 is arranged to self-power the device 200. The energy harvesting means 220 may harvest energy from one or more of solar, kinetic, magnetic or RF energy. The energy harvesting means 220 may be an energy harvesting unit 220 of the device 200. The energy storage means 225 may be one or both of a capacitor or battery based energy storage device. The choice of storage device 225 may depend, at least in part, upon the source of energy for the energy harvesting unit 220. For example, solar power may require gradually-harvested energy to be stored for a longer period of time than, for example, a kinetic source of energy which may require shorter-duration storage. Thus a capacitor-based storage device 225 may be used in embodiments based on kinetic, magnetic or RF energy whilst a battery-based storage may be used for embodiments based on solar energy.

In some embodiments the energy harvesting unit (EHU) 220 comprises one or more solar panels for harvesting solar energy. In one embodiment the one or more solar panels are arranged on a rear surface of the device 200 such that the rear surface of the device may form a surface of the vehicle. That is, the rear of the device 200 having the one or more solar panels thereon is co-planar in use with one or more adjoining outer surfaces of the vehicle. For example, in the arrangement of FIG. 1, the device 100, 200 may the cover of the vehicle or a portion of the cover 10 i.e. the rear surface is exposed through an aperture in the cover 10. Thus the device 100, 200 may be mounted upon the mechanism 30 to be openable and closeable. The one or more solar panels may be coloured to match or be similar to a colour of the outer surfaces of the vehicle.

In other embodiments, the EHU 220 is arranged to convert kinetic energy to electrical energy for the operation of the device 200. The kinetic energy may be provided by movement of the cover 10 between the closed and open positions. The EHU 220 comprises a mechanical connection to the mechanism 30 or region 25 proximal to the fuel connection 20 via which the movement of the cover 10 actuated by the user or an actuator is converted to electrical energy. The connection may be, for example, an arm. The connection may cause rotation of an electrical generator of the EHU 220. A movement speed increasing mechanism such as a gearbox may interpose the connection and the generator to increase the rotational speed.

In still other embodiments the EHU 220 comprises one or more magnets and/or coil(s), forming an electrical generator, which are arranged to move responsive to movement of the cover 10 with respect to the vehicle and to generate electrical energy in response thereto.

In still further embodiments, the EHU 220 comprises one or more piezoelectric devices. Movement of the cover 10 is arranged to apply pressure to the one or more piezoelectric devices such that electrical energy is provided in response thereto. The one or more piezoelectric devices may be piezoelectric crystals.

In other embodiments, the EHU 220 comprises means for harvesting energy from RF signals. The means may be one or more antenna or coils for receiving RF signals. The vehicle may be provided with a transmitter antenna or coil which is energised to transmit in dependence on the cover 10 being opened, such that the electrical energy is produced in the antenna(s) or coil(s) of the EHU 220 sufficient to power the device 200. The transmission by the vehicle may wake the device 200 and subsequently communicate the vehicle information, as will be described.

The energy storage means 225 is an energy storage device 225 or storing energy provided from the EHU 220. The energy storage device 225 may store the energy for a short period of time, for example up to 5 or 10 seconds in some embodiments. In other embodiments, the energy storage device 225 may store energy for longer durations such as hours or, in some embodiments up to one or several days. It will be realised that these durations or time are not limiting and are examples.

As noted above, the display device 100, 200 is arranged to wirelessly communicate with a wireless communication system of the vehicle to receive the vehicle information. The device 200 comprises the communication means 230 for wirelessly communicating with one or more systems of the vehicle to obtain the vehicle information. The communication means 230 may be a communication unit 230. The communication unit 230 is arranged for short-range communication with the vehicle. Short-range communication may be up to 20 cm or 10 cm, although other distances may be envisaged. The communication may be one of optical, RF or inductive based. In one embodiment the device 100, 200 may comprise a means for optically outputting and receiving data with a corresponding device of the vehicle. The means may be an opto-isolator or opto-coupler. The communication unit may support a protocol such as one or Near Field Communication (NFC), Bluetooth, including low-power Bluetooth (Bluetooth_LE). It will be realised that other communication protocols may be used. The communication unit 230 may support burst communication with the vehicle. Advantageously, the short range of the communication unit 230 consumes only a relatively small amount power, thus reducing a burden on the EHU 220. The communication unit 230 may comprise one or more antennas or coils for supporting the wireless communication.

The vehicle information received by the device 200 via the communication unit 230 is indicative of a status of one or more systems of the vehicle. The one or more systems of the vehicle may comprise one or more of a braking system, a cooling system, a fuel system, wheels and/or tyres of the vehicle, a lighting system of the vehicle and a towing system of the vehicle. The vehicle information may comprise service information indicative of a status of one or more serviceable or rechargeable items of the vehicle such as one or more fluid levels (coolant fluid, washer fluid, oil etc). The vehicle information may comprise information indicative of faults relating to the vehicle and the vehicle's systems. The vehicle information may comprise service information indicative of when the vehicle next requires servicing or maintenance.

In particular, in one embodiment, the vehicle information may comprise information indicative of one or more of brake level or wear, tyre pressure, fuel level (gas, liquid and/or electrical), coolant fluid level, washer fluid level, oil level, trailer state (e.g. tow bar state e.g. deployed/stowed, trailer connected, lights operative, power connected, trailer weight, brakes functioning etc.), next service required (date or mileage) and any vehicle faults.

In some embodiments the vehicle information may comprise vehicle instruction information. The instruction information is for informing a user how to complete one or more actions or tasks associated with the vehicle. The actions or tasks may comprise one or more of how to deploy the tow bar of the vehicle, how to hitch a trailer to the vehicle, how to electrically connect the trailer to the vehicle, how to change a wheel of the vehicle and charging or refuelling instructions for the vehicle, particularly where the vehicle is hybrid or electrically powered.

In some embodiments, priority information is assigned to at least some of the vehicle information. The priority information is indicative of an importance of the associated information. In one embodiment the priority may be a flag or marker associated with vehicle information having a higher priority. In other embodiments, each item of vehicle information comprises an associated priority level. For example, the priority level may be defined as one of 1 (highest) to 10 (lowest), although other ranges of priority may be used. As will be explained, the priority allows the device 100, 200 to advantageously display most important vehicle information.

The vehicle information received via the communication unit 230 is provided to the control unit 210. The control unit 210 is arranged to control the visual display means 240 to visually output thereon an indication of at least some of the received vehicle information, as will be explained.

The visual display means 240 for visually outputting an indication of the vehicle information.

The visual display means 240 may comprise, in one embodiment, one more light emitters such as LED or LCD devices for outputting the indication of the vehicle information.

In another embodiment, the visual display means 240 comprises a display device 240. The display device 240 comprises a screen for outputting the indication of the vehicle information under control of the control unit 210. The display device 240 may be a low-power display device, such as one that does not require a backlight to display information thereon. The display device 240 may only consume energy to alter an output of the display device i.e. power is not consumed to maintain the output of the display device 240. The display device 240 may be a paper-like or electrophoretic display device 240. An electrophoretic display device 240 comprises cells of pigment particles such as black and white particles which can be controllably used to colour the cell based on charge applied to the cell, as will be appreciated. Advantageously the display retains an image displayed thereon, even without power. Thus the electrophoretic display device 240 does not use substantial power to continually display the vehicle information. Power is only used to change the information displayed. Advantageously the energy requirements of such display devices are reduced.

The control unit 210 is arranged to control the display device 240 to output at least some of the vehicle information received from the communication unit 230. In one embodiment the control unit 210 is arranged to control the display device 240 to display a representation of all of the received vehicle information simultaneously. However in other embodiments, the control unit 210 is arranged to control the display device 240 to display a representation of only some of the vehicle information at once.

In one embodiment the control unit 210 divides the vehicle information into a plurality of pages. Each page comprises related information. For example, a first page may comprise representations of vehicle information related to fluids whilst a second page comprises representations of vehicle information related to brakes. It will be realised that the number of pages is not limited to two and that the topics associated with each page are merely illustrative. The control unit 210 may alternate amongst the plurality of pages, such as in a predetermined sequence, according to one of a timer automatically i.e. each page is displayed for a predetermined period of time, or in dependence on a user input received via the user input means 120, 250.

In one embodiment, at least some of the pages of vehicle information comprise vehicle information selected by the control unit 210. The control unit 210 may select vehicle information based on the priority information associated with at least some of the vehicle information. In one embodiment, the control unit 210 is arranged to display one or more pages of vehicle information having a higher priority. For example, where the higher priority vehicle information has the flag or marker associated therewith, one or more pages of vehicle information displayed first comprise the higher priority vehicle information. Alternatively where vehicle information comprises an associated priority level, the vehicle information may be ordered across the plurality of pages based on the associated priority levels, depending upon how many items of vehicle information are displayed per page. In these way, the user is provided with the most important vehicle information first. For example, if an oil level of the vehicle's engine has a low oil level, the vehicle information indicative of oil level may be associated with the flag or a high priority level such as 1. The control unit 210 thus controls the display device 240 to display a first page comprising a representation of the oil level vehicle information. The display device 240 may comprise an indication of the high priority such as a visible indicator.

The user input means 120, 250 comprises, in one embodiment, an actuator, such as a button, which is pressed by a user. In other embodiments, the user input means 120, 250 may be one of a touch or light sensitive device which is operable by a user to provide a user input to the control unit 210. The touch sensitive device may be, for example, a capacitance-based sensor device. In other embodiments the user input means 120, 250 may be voice operated. The user input means 120, 250 is provided to allow the user to provide an input to the control unit 210. The input may signal the control unit 210 vary information displayed on the display device 240, such as selecting or scrolling between the plurality of pages of vehicle information, as described above.

As noted above, in some embodiments the display device 100, 200 is formed in a substantially sealed construction. That is, the display device 100, 200 is an integral device which is self-supporting. The display device 100, 200 is formed as a single unit self-contained device with its own source of power which wirelessly communicates with the vehicle. A casing of the device 100, 200 substantially encapsulates the units of the device 100, 200 such as those shown in FIG. 2.

In particular, in some embodiments, the display device 100 is substantially waterproof and may also be substantially gas or vapour proof. In particular, in some embodiments, the display device 100 is substantially waterproof and may also be substantially gas or vapour proof. Advantageously safety of using the device 100, 200 with the vehicle is increased. For example, the device 100, 200 does not pose a substantial ignition risk especially where the vehicle is gas or liquid fuel powered. Furthermore, the units of the device 100, 200 are protected from the vehicle's fuel.

In some embodiments the device 100, 200 is formed by in-mould construction. In such in-mould construction the units of the device such as those shown in FIG. 2 are placed within a mould. The units may be installed upon one or more circuit boards which, in the case of a plurality of circuit boards, may be mechanically connected in fixed-relation such as spaced apart. The one or more circuit boards are then placed into the mould. The mould is then filled within a material such as a resin or plastic to form a case or exterior of the device 100, 200. The case may be formed to seal the device 200 around the units therein whilst allowing the display device 240 to remain visible, such as by sealing around the display device 240 and, in some embodiments, user input means 120, 250.

In other embodiments, the case of the device 100, 200 may be formed around the units such as by 3D printing.

In other embodiments, the device 100, 200 may be formed by printed electronics. For example, one or more non-conductive layers have electronic circuits printed thereon. In some embodiments a plurality of layers are formed together sandwiching the electronic circuits there-between. Exterior layers of material may be applied to form the casing of the device 100, 200 to substantially seal the device 100, 200. The printed electronics can be part of the above described in-mould construction. The device formed using the printed electronics can substantially reduce the thickness of the casing of the device further.

FIG. 3 illustrates a method 300 according to an embodiment of the invention. The method is a method 300 of providing vehicle information. The method 300 may be performed by a self-contained display device 100, 200 according to an embodiment of the invention. A memory of the device 100, 200 may store computer-executable instructions that, when executed by at least one processor of the device 100, 200 performed the method 200.

The method 300 comprises a step 310 of harvesting energy. The energy is harvested to power the device 100, 200 to perform the method 300. Step 310 may be performed on a continually basis, or at least when sufficient ambient light allows one or more solar panels to generate electrical energy. As described above, the energy may be stored in the energy storage means 225 which may be battery-based for long-duration storage.

In other embodiments, step 310 is performed responsive to an event. The event may be movement of the cover 10 from the closed position to the open position in which the device 100, 200 is visible. The movement may be caused by the user i.e. manually, or by an actuator associated with the cover 10 which is powered by the vehicle. In these embodiments, kinetic energy associated with the movement is converted to electrical energy by the EHU 220. In other embodiments, the event may correspond to energy being induced in the EHU 220 of the device 100, 200 such as by magnetic coupling or an RF signal. For example, the vehicle may energise a coil proximal to the device 100, 200 in dependence on the cover 10 being opened. Energy is induced in the EHU 220, such as in a coil of the EHU, responsive to that in the vehicle coil. In this way the EHU 220 wirelessly harvests energy from the vehicle. The electrical energy may be stored, at least temporarily, in the energy storage means 225, which may be capacitor based.

FIG. 4 illustrates a graph of energy (y-axis) against time (x-axis) during the method 300. As indicated in FIG. 4, step 310 corresponds with increasing energy, such as increasing voltage, within the device 100, 200.

The method 300 comprises a step 320 of wirelessly receiving vehicle information. The vehicle information may be received from a communication system of the vehicle. Step 320 may be performed once the EHU 220 has harvested sufficient energy for the communication unit 230 to operate. As shown in FIG. 4, step 320 may be performed when a voltage provided to the communication unit 230 reaches a predetermined level. The communication unit 230 is energised by the harvested energy such that the vehicle information is received from the vehicle.

The method 300 comprises a step 330 of visually outputting an indication of the vehicle information. The visual indication may be output in a region proximal to the fuel connection 20 of the vehicle, such as a liquid or gas fuel filler or electric charging port of the vehicle. That is, the device 100, 200 may be located proximal to the fuel connection 20 such as region 25 indicated in FIG. 1. As described above, in some embodiments the display device 240 is updated in step 330. Thus an output of the display device 240 is maintained after step 330 i.e. vehicle information is continued to be displayed on the display device 240 after step 330.

The method 300 may then return to step 310, although it will be appreciated that step 310 may be performed in some embodiments throughout the duration of the method 300, such as where step 310 is based upon solar power. In other embodiments, a period of time may exist between execution of steps 330 and 310 for example where the cover 10 is moved to the closed position following step 330, such as on completion of fuelling of the vehicle, and step 310 is then executed when the cover 10 is next moved to the open position.

It will be appreciated that embodiments of the invention provide vehicle information at a convenient when the user is likely to have cognitive capacity to appreciate the vehicle information.

It will be appreciated that embodiments of the present invention can be realised in the form of hardware, software or a combination of hardware and software. Any such software may be stored in the form non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A vehicle, comprising:
a moveable cover on an external surface of the vehicle, the movable cover covering a fuel connection of the vehicle, and a self-contained display device arranged in relation to the cover such that the self-contained display device is arranged generally behind the cover when the cover is in a closed position, the self-contained display device comprising:
an energy harvesting unit arranged to generate electrical energy powering the self-contained display device;
a communication unit arranged to wirelessly communicate with a vehicle communication unit to obtain vehicle information; and
a visual display device arranged to visually output an indication of the vehicle information.

2. The vehicle of claim 1, wherein the self-contained display device is proximal to a fuel connection of the vehicle.

3. The vehicle of claim 1, wherein the energy harvesting unit comprises a solar device arranged to convert incident solar energy into electrical energy.

4. The vehicle of claim 1, wherein the energy harvesting unit comprises a kinetic device arranged to convert kinetic energy into electrical energy.

5. The vehicle of claim 4, wherein the kinetic energy is provided by movement of the cover between the closed position and an open position.

6. The vehicle of claim 1, wherein the energy harvesting unit comprises an energy storage device arranged to store energy generated by the energy harvesting device to power the self-contained display device.

7. (canceled)

8. The vehicle of claim 1, wherein the vehicle information comprises information indicative of a state of one or more consumables of the vehicle.

9. (canceled)

10. The vehicle of claim 1, wherein the vehicle information comprises information indicative of a state of one or more vehicle systems.

11. (canceled)

12. The vehicle of claim 1, wherein the self-contained display device is arranged to be visible when the cover is in an open position.

13. The vehicle of claim 1, wherein the self-contained display device is substantially sealed.

14-16. (canceled)

17. A self-contained display device for mounting relative to a moveable cover of a vehicle, the self-contained display device comprising:
an energy harvesting unit arranged to generate energy for powering the self-contained display device;
a communication unit arranged to wirelessly communicate with a vehicle communication unit to obtain vehicle information; and
a visual display device arranged to visually output an indication of the vehicle information, wherein the visual display unit is arranged generally behind the cover of the vehicle when the cover is in a closed position.

18. The display device of claim 17, wherein the self-contained display device is formed in a substantially sealed casing.

19. (canceled)

20. The display device of claim 17, wherein the energy harvesting unit comprises one or more of a solar device arranged to convert incident solar energy into electrical energy, a kinetic device arranged to convert kinetic energy into electrical energy and a wireless device arranged to convert magnetic or RF energy into electrical energy.

21. (canceled)

22. The display device of claim 17, wherein the communication unit is operative according to a short-range communication protocol to communicate with the vehicle communication unit.

23. The display device of claim 17, wherein the visual display device is one of an electrophoretic display device or a bi-stable display device.

24. (canceled)

25. The display device of claim 23, wherein the communication unit is arranged to communicate with the vehicle communication unit immediately following the energy harvesting unit harvesting energy and the display device is updated following receipt of the vehicle information.

26. A method of providing vehicle information, comprising:
generating energy by a self-contained display device, wherein the display device is arranged proximal to a moveable cover of a vehicle such that the display device is behind the cover in a closed position;
wirelessly receiving, at the display device, vehicle information from the vehicle; and
visually outputting an indication of the vehicle information from the display device.

27. The method of claim 26, wherein the generating is performed responsive to the cover moving from the closed position to an open position; optionally the generating is harvesting of kinetic energy of the cover opening.

28. (canceled)

29. A computer program product, comprising a non-transitory computer readable storage medium having encoded thereon instructions that, when executed by a processor, cause the processor to perform the method according to claim 26.
